(19) United States
(12) Patent Application Publication
(10) Pub. No.: US 2004/0205590 A1
(43) Pub. Date: Oct. 14, 2004

(54) Extensible object-oriented document system and method

(75) Inventors: David W. Smith, Beaverton, OR (US); James Scot Johnston, Wilsonville, OR (US)

Correspondence Address: Marger Johnson & McCollom, P.C., 1030 S.W. Morrison Street, Portland, OR, 97205, US

(73) Assignee: IronSpire, Inc., Tigard, OR

(21) Appl. No.: 10/214,724

(22) Filed: Aug. 7, 2002

Related U.S. Application Data
(60) Provisional application No. 60/310,790, filed on Aug. 7, 2001.

(51) Int. Cl. G06F 15/00

(52) U.S. Cl. 715/513

(57) ABSTRACT

A document type can be defined using existing or newly-defined item types. A document instance is created using the document type. Roles are assigned to users, and users can interact with the document instance. Finally, the document instance can be processed in a workflow.

### RELATED APPLICATION DATA

This application claims priority from U.S. Provisional Patent Application Serial No. 60/310,790, filed Aug. 7, 2001, which is hereby incorporated by reference.

### FIELD OF THE INVENTION

This invention pertains to documents, and more particularly to the creation and management of extensible documents in a computer.

### BACKGROUND OF THE INVENTION

A new class of applications has been developed recently for providing collaborative environments for sharing of information between members on a team via computers. There are many-problems to be faced when creating these applications relating to security, ease of use, network and Internet access, workflow definition, and the manner of structuring and storing the information to be shared.

The most common method way of defining the data to be shared is to store all of the information in an external file and link this to the application. Minimal information is then kept about the file that can be used to tell who added the file and when it was added to the application. Other information can be added, under control and definition of the application, which can be used for workflow routing. The actual contents of the document are essentially meaningless to the application, except possibly for searching for text in the document. Applicants use this method in version 1 of the JobSite™ and ForeSite™ products (IronSpire, Inc., Portland, Oreg.). Microsoft also uses the above methodology in the upcoming Tahoe Server, eRooms, and Buzzsaw and ConstructWare for their web-based collaboration products.

A second method used to store information is by defining a proprietary data scheme for the document type and then building proprietary views and controls for this new document type. This makes the addition of a new document very costly and is only possible by the vendor. The advantage of this method is that the contents of the document are completely known by the vendor and therefore information can be used between different functions within the application. Examples of this are the newly announced Request For Quotes (“RFQ”) module for Buzzsaw and all of the Request For Information (“RFI”), RFQ, and Submittal documents for ConstructWare.

In many industries, there are certain types of documents that are recognized throughout the industry. For example, in the legal community, there are documents such as contracts, licenses, interrogatories, and so on. In the construction industry, documents such as the Request for Information and Request for Quotes have known and understood significances.

But even though the types of documents are commonly recognized within the industry, the exact structure and layout of the document can vary to some degree. Each business customizes the documents to some extent, to suit their internal preferences. These customizations can be purely cosmetic (e.g., including the name of the particular business generating the document), or can be functional, in that the customizations track data not normally included in the document.

Although document content is easily modified by users, document forms are not so easily modified. Customization, even of cosmetic changes, involves programming the computer, particularly with regard to how programs interact with the documents. Thus, customizing the documents requires software vendors to deliver different versions of the same product to different customers.

In addition to the complexity of customizing the documents, cross-compatibility is lost once customization has been completed. That is, a document generated by one version of the software vendor's product cannot be read by a different version of the product. Even the smallest change destroys the possibility of sharing documents between different versions of the product.

Finally, the ability to perform data mining, that is, to analyze documents for data they contain, is dependent on the data-mining software being able to decipher the document form. Document customization means that the data-mining software must also be customized, and means that documents from different companies cannot be mined together.

A need remains for a way to allow document customization that addresses these and other problems associated with the prior art.

### SUMMARY OF THE INVENTION

The subject matter of the present invention deals with the structure and storage of information to be shared and how it relates to other processes such as workflow. The present invention enables a real-time knowledge management application, integrating multiple technologies to address construction information management within a web-enabled object-oriented database system. The extensible object-oriented system can be based upon the Microsoft 3-tier architecture, comprising new data schema, advanced security, and room structures. The system allows major customers or Value Added Resellers (VARs) to manage site creation and user licensing, facilitating rapid scaling and growth of user base. Further, the present invention supports the eXtensible Markup Language (XML) for information sharing across applications and to import/export data.

The Extensible Document Management System technology allows an administrator or customer to create “on-the-fly” data schemas and dynamic documents. Customers thereby are permitted to easily customize the type of information captured and how that information is viewed and managed. The system provides a simple mechanism for data sharing across applications. As well, customer branding is enabled, so that a client user can create a custom look-and-feel to transparently present the software as their unique offering for their teams. Localization of the application supports multiple languages and preferences.

The invention is a method and apparatus for managing document types. In a computer system, a document type manager enables users to manage document types, including defining and redefining item and document types. A document view manager supports viewing documents in any number of views, both for review and editing. A document workflow manager manages delivery of documents to various persons, as defined by the document author, an administrator, or within the document type.

In one embodiment, a document type is defined, including a role for a user of the document. A document is created using the document type, and a user is assigned to the role. Users interact with the document, and the document is routed using a workflow.

The foregoing and other features, objects, and advantages of the invention will become more readily apparent from the following detailed description, which proceeds with reference to the accompanying drawings.

### BRIEF DESCRIPTION OF THE DRAWINGS

FIG. 1 shows a computer system including components to manage documents and document types, according to an embodiment of the invention.

FIG. 2 shows the computer system of FIG. 1 connected to other computer systems via a network, according to an embodiment of the invention.

FIG. 3 shows a relationship between documents, document types, and item types in the computer system of FIG. 1 according to an embodiment of the invention.

FIGS. 4A-4H show use cases for manipulating documents and document types in the computer system of FIG. 1, according to an embodiment of the invention.

FIGS. 5-7 show a definition of item and document types using the document type manager of FIG. 1, according to an embodiment of the invention.

FIGS. 8-10 show a definition and use of a view for a document using the document view manager of FIG. 1, according to an embodiment of the invention.

FIGS. 11-12 show a logging of activity and display of activity for a document using the document history manager of FIG. 1, according to an embodiment of the invention.

FIG. 13 shows a workflow of a document using the document workflow manager of FIG. 1, according to an embodiment of the invention.

FIGS. 14A-14D show different workflows for a document using the document workflow manager of FIG. 1, according to an embodiment of the invention.

FIG. 15 shows a sample document with different value types as can be used in the computer system of FIG. 1, according to an embodiment of the invention.

FIG. 16 shows a sample container structure for documents in the computer system of FIG. 1, according to an embodiment of the invention.

FIG. 17 shows a flowchart of the procedure for the lifecycle of a document in the computer system of FIG. 1, according to an embodiment of the invention.

FIGS. 18A-18B show a flowchart of the procedure for defining a new document type in the computer system of FIG. 1, according to an embodiment of the invention.

FIGS. 19A-19B show a flowchart of the procedure for managing a document workflow in the computer system of FIG. 1, according to an embodiment of the invention.

### DETAILED DESCRIPTION OF THE PREFERRED EMBODIMENT

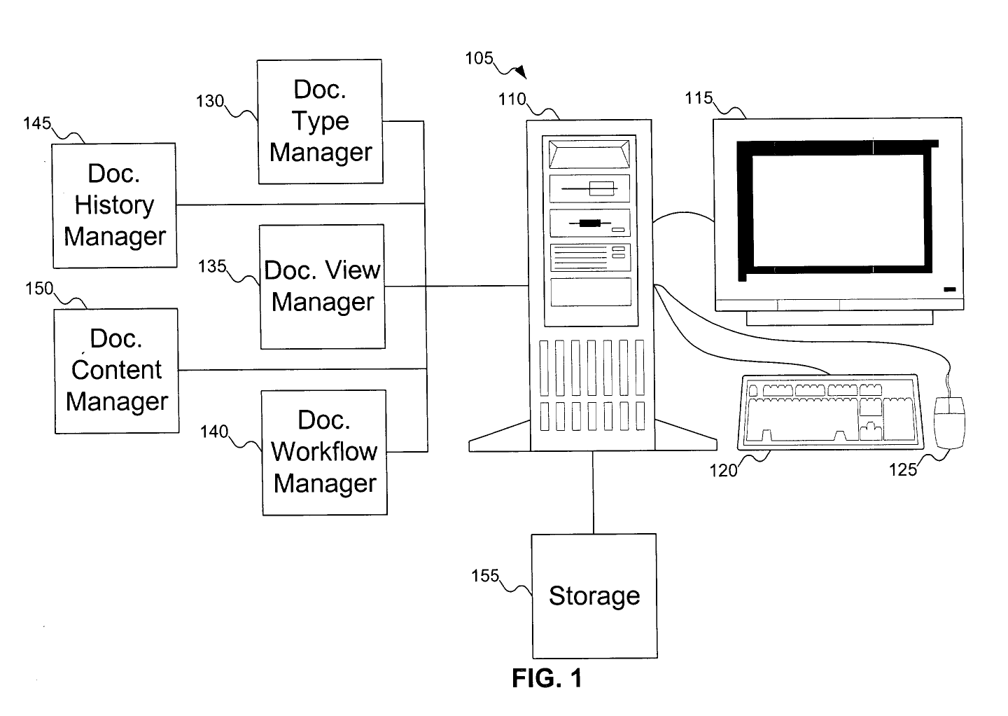

FIG. 1 shows a computer system including components to manage documents and document types, according to an embodiment of the invention. In FIG. 1, computer system 105 conventionally includes computer 110, monitor 115, keyboard 120, and mouse 125. A person skilled in the art will recognize that although computer system 105 is shown as a desktop personal computer, the invention is not limited to any specific type of computer. For example, computer system 105 could also be an Internet appliance, lacking monitor 115, keyboard 120, or mouse 125. Computer system 105 could also be a personal digital assistant (PDA), or a wireless computer. Optional equipment not shown as part of computer system 105 in FIG. 1 are other input/output devices, such as a printer or a modem. Also not shown in FIG. 1 are the conventional internal components of computer system 105: e.g., a central processing unit, memory, file system, network interface, etc.

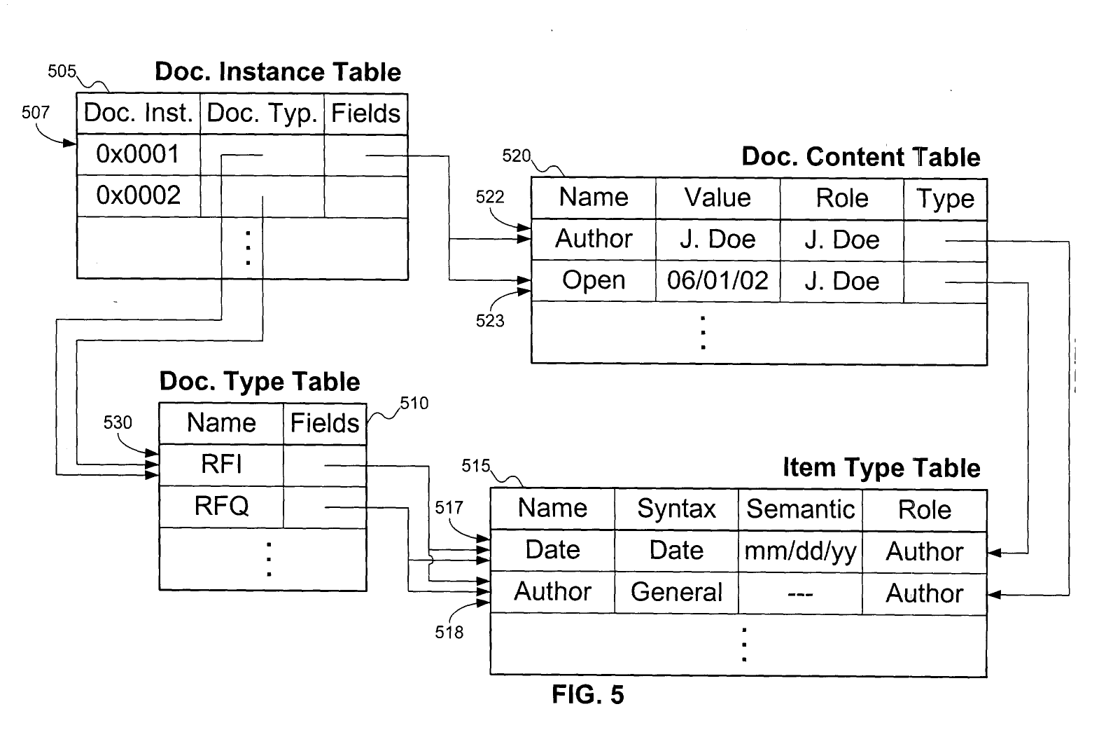

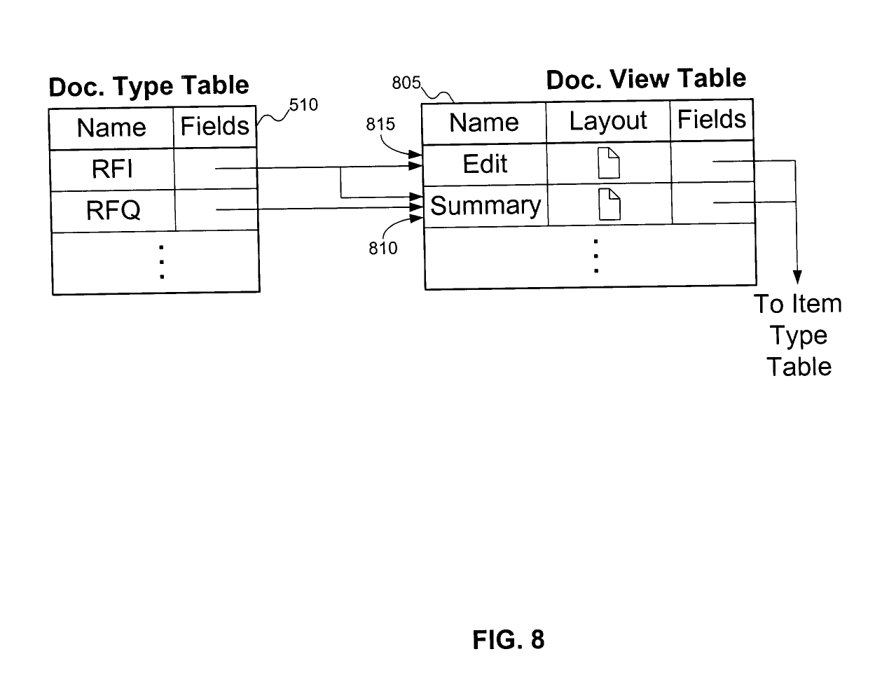

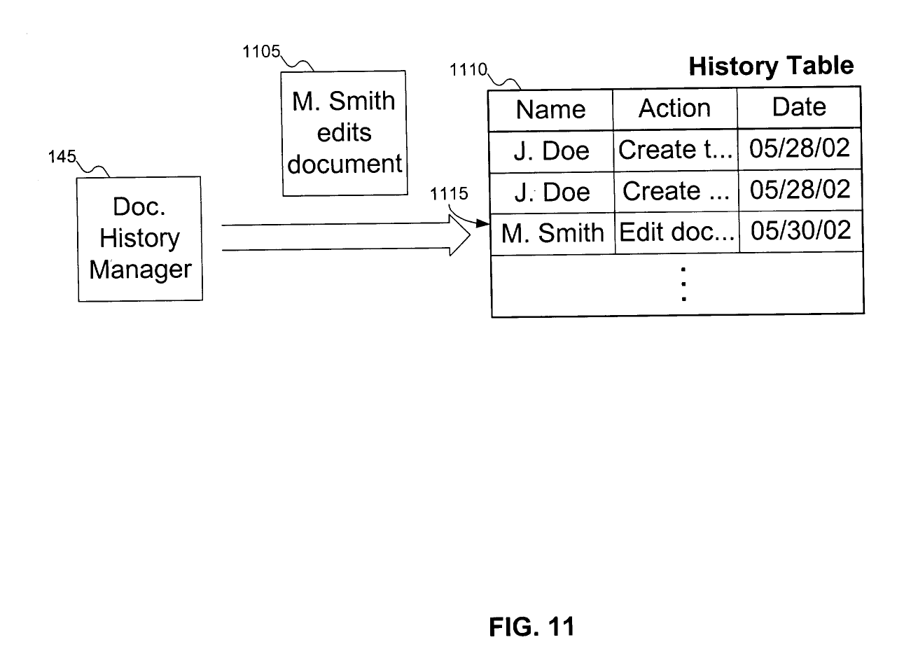

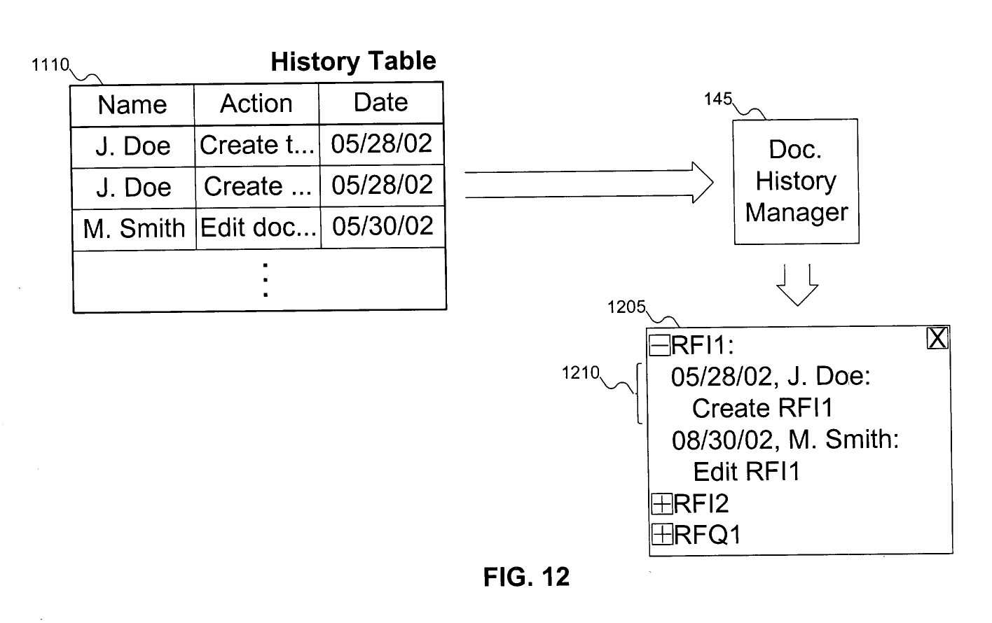

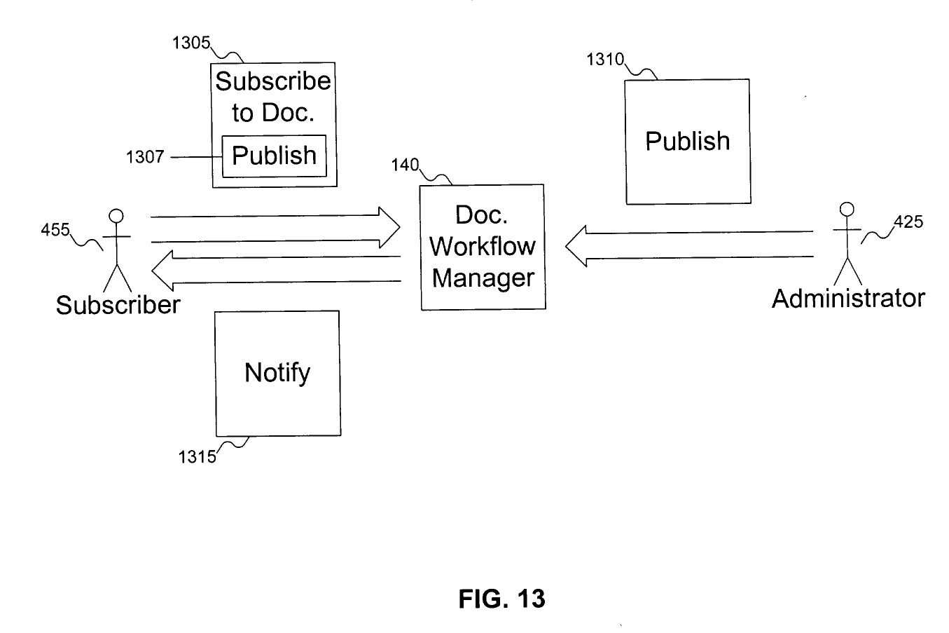

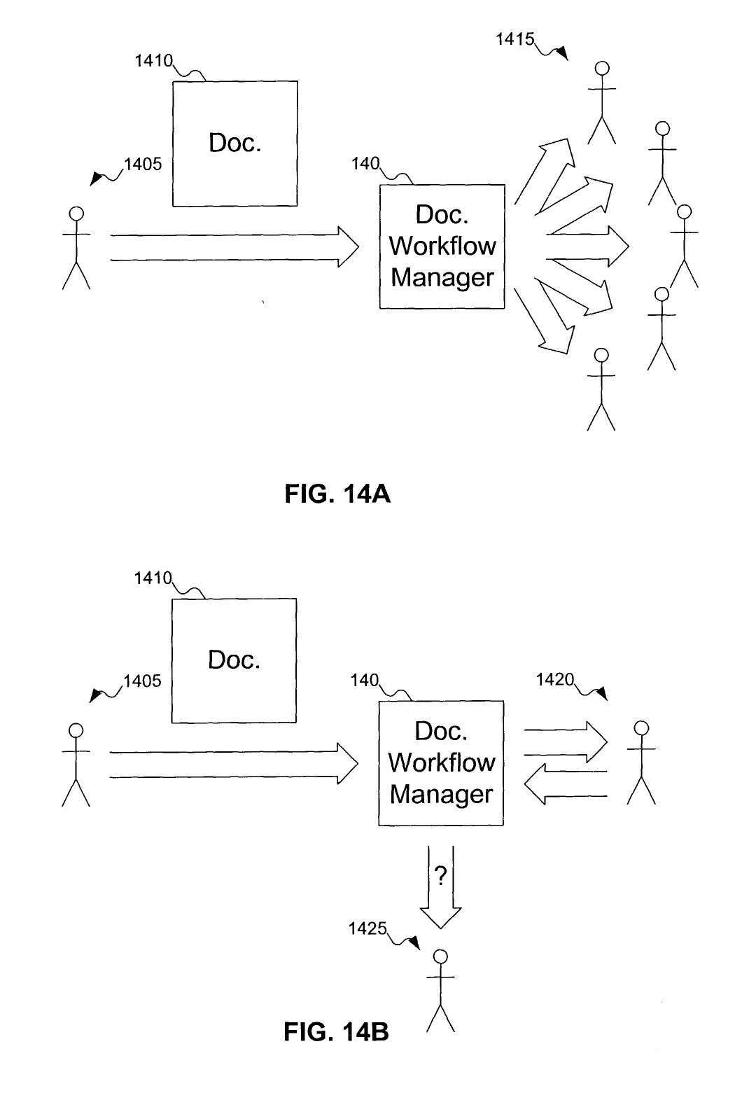

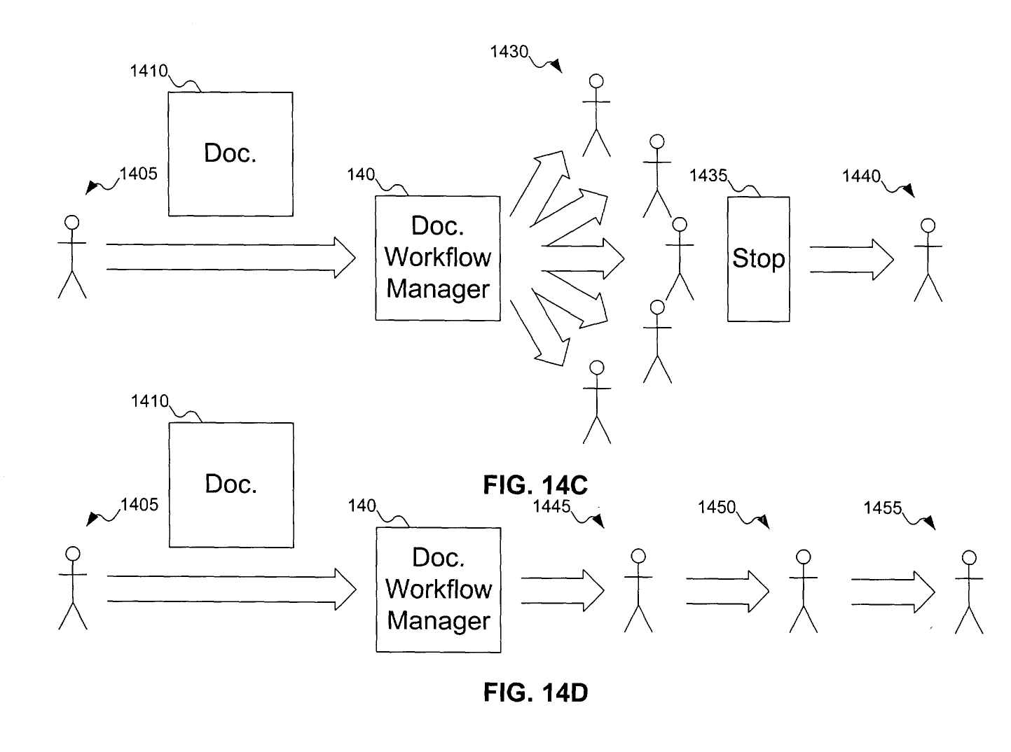

Computer system 105 includes various components, each designed to accomplish specific goals. Document type manager 130 manages the definition of item and document types, and is discussed further below with reference to FIGS. 5-7. Document view manager 135 manages document views, which users can use to display the documents (or portions thereof), and is discussed further below with reference to FIGS. 8-10. Document workflow manager 140 manages document workflow, which includes such tasks as routing documents to appropriate persons. Document workflow manager 140 is discussed further below with reference to FIGS. 13-14D. Document history manager 145 manages the history of documents within the system, and is discussed further with reference to FIGS. 11-12 below. Document content manager 150 is responsible for managing the content of documents. Although not described uniquely in any figure, document content manager 150 is discussed throughout this document.

When implemented as software, the various managers 130-150 can be stored in storage 155. Storage 155 can be any of a variety of storage devices usable in computer system 105. For example, storage 155 can be random access memory (RAM), hard disk storage, optical disc storage, flash memory, or any other variety of storage. In a similar vein, storage 155 can be used to store the contents of the documents used in the system, as well as the document and item type definitions, document views, and other elements of an embodiment of the invention.

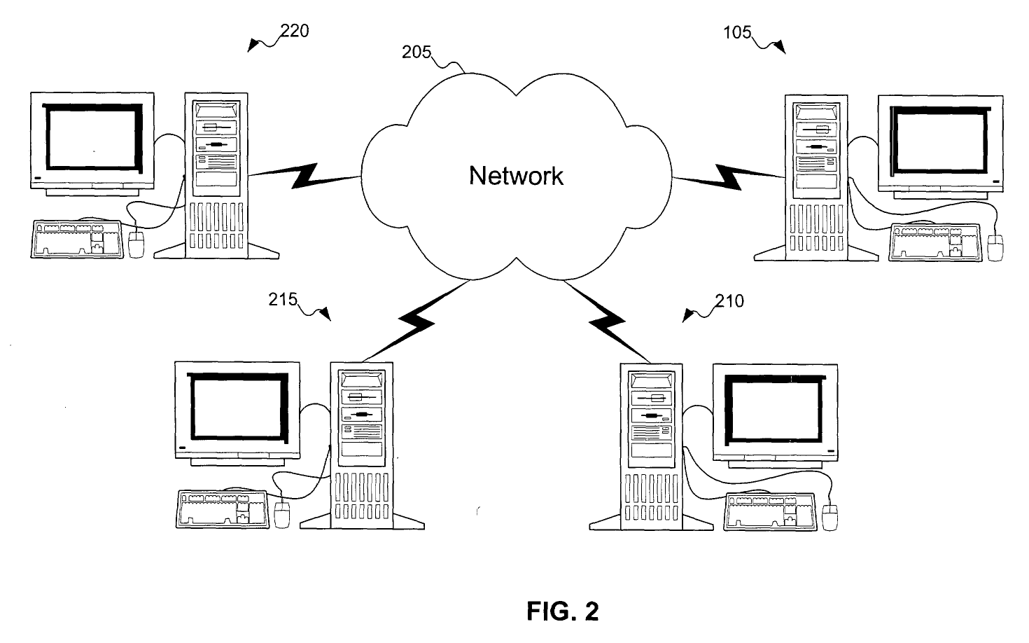

FIG. 2 shows the computer system of FIG. 1 connected to other computer systems via a network, according to an embodiment of the invention. As discussed below with reference to FIGS. 13-14D, documents can be delivered to other users. The other users have computer systems of their own, connected to computer system 105 via network 205, to accomplish communication. Then, when documents need to be routed to other users, the routing can cross network 205. A person skilled in the art will recognize that there are no limitations imposed on computer systems 210, 215, or 220 any more than are imposed on computer system 105. Further, network 205 can be any type of network capable of connecting the various computer systems: an intranet, an extranet, a global network (such as the Internet), a wireless network, a network for PDAs, or a virtual private network (VPN), to name a few.

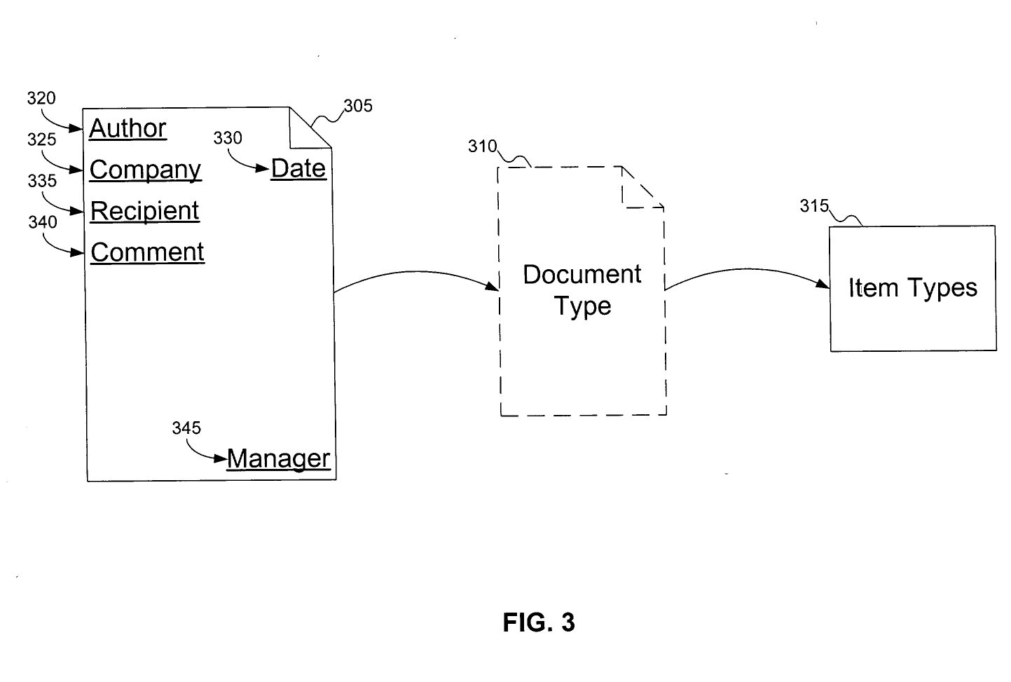

FIG. 3 shows a relationship between documents, document types, and item types in the computer system of FIG. 1 according to an embodiment of the invention. In FIG. 3, document 305 is shown. Document 305 can also be called a document instance, suggesting that document 305 is an instance of a particular type of document, in FIG. 3 document type 310. Document type 310 is not a document per se, but rather defines the layout and the fields used in documents of document type 310. Confusion can result between the terms “document” and “document type.” To avoid this confusion, the term “document” will mean a “document instance,” and the term “document type” will be used when referring to a type of document.

As just mentioned, document type 310 defines fields used in documents of document type 310. Afield is a particular piece of datum in a document. Each field has a particular type, called an item type. An item type defines a generic type that can be used by any field in a document. Commonly recognized item types are text strings, numbers, percentages, dollar amounts, etc. Using the document type manager, as discussed further below with reference to FIGS. 5-7, a user can define new item types, customized to their particular need. Item type set 315 is the set of all item types defined in the particular implementation of an embodiment of the invention.

The reason a distinction is drawn between an item type and a field is that a field is specific to a document type, whereas an item type can be reused many times, both across and within document types. Fields can also be given customized names without losing the name of the field's item type.

Returning now to document 305, the reader will understand that document 305 includes several fields with item types drawn from item type set 315. Document type 310 identifies which fields are used in document type 310. When a user creates an instance of the document type (such as document 305), these fields can be given values by the user. For example, fields 320-345 are all fields to which the user can assign values.

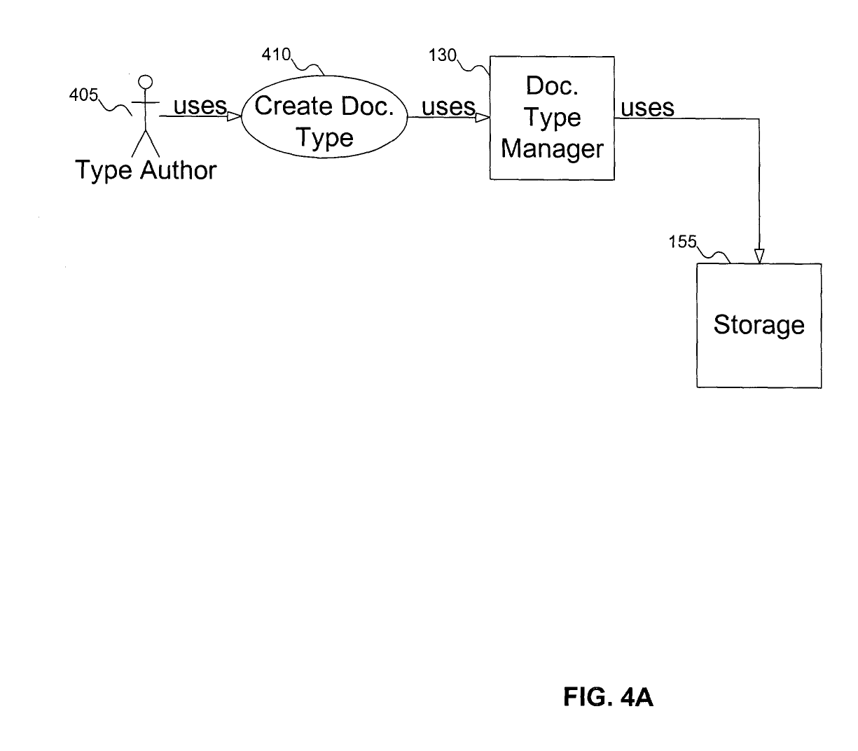

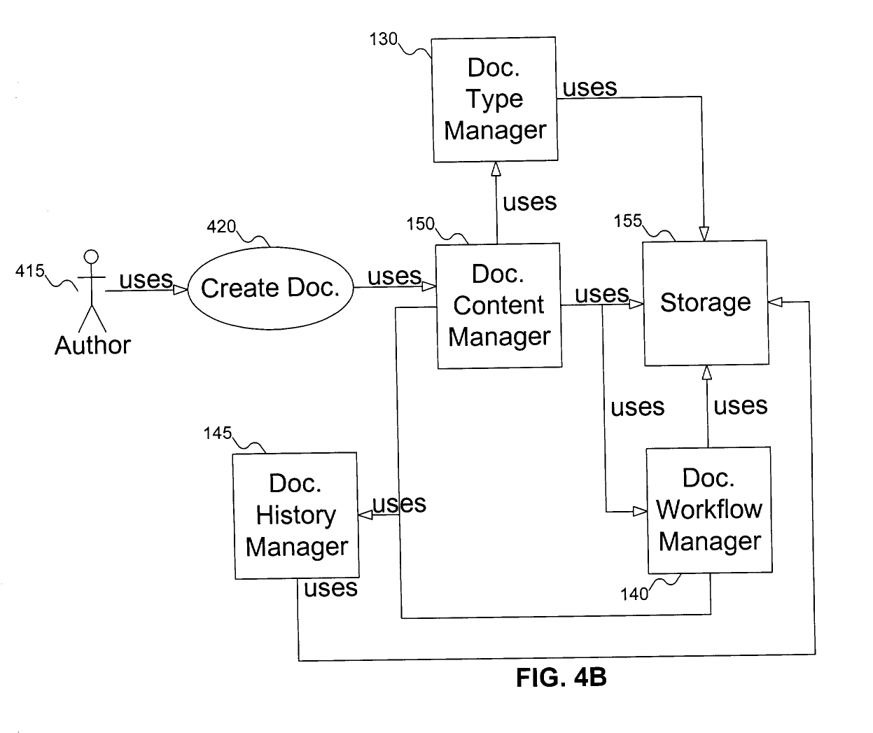

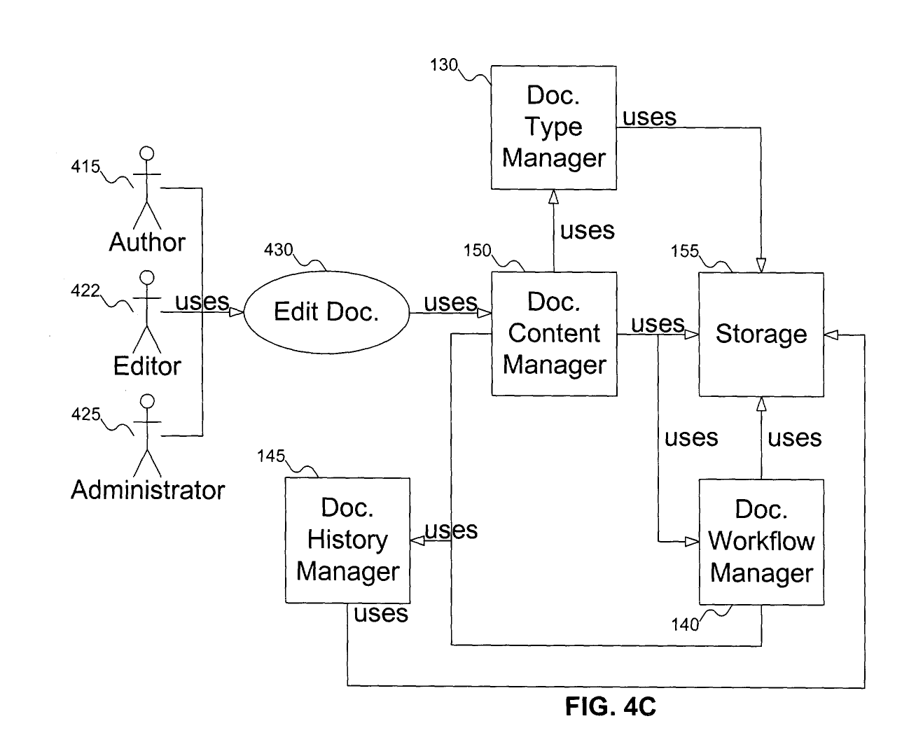

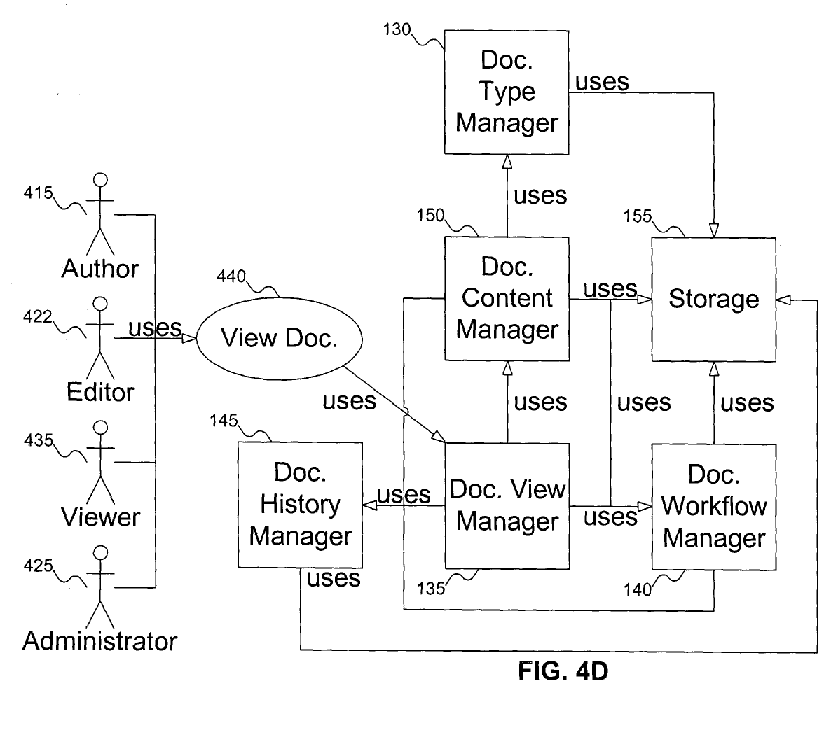

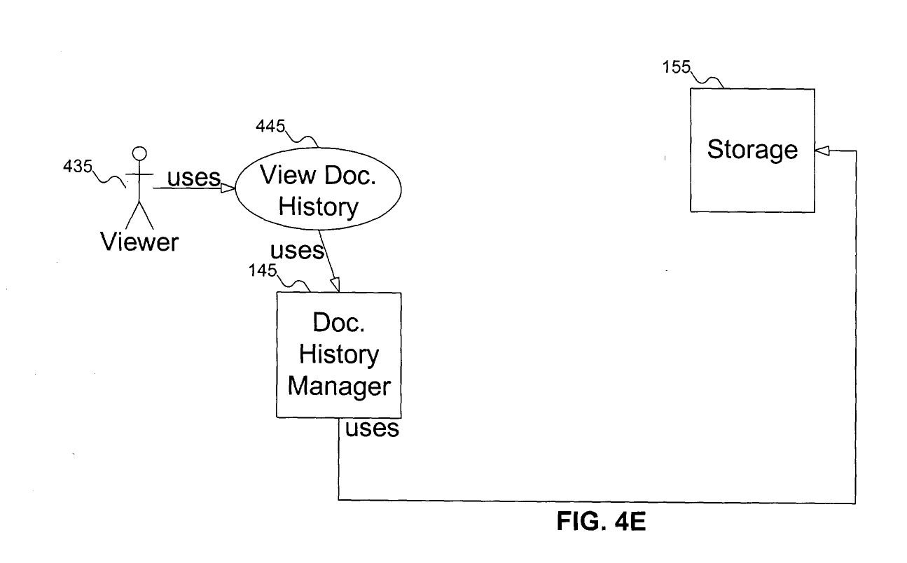

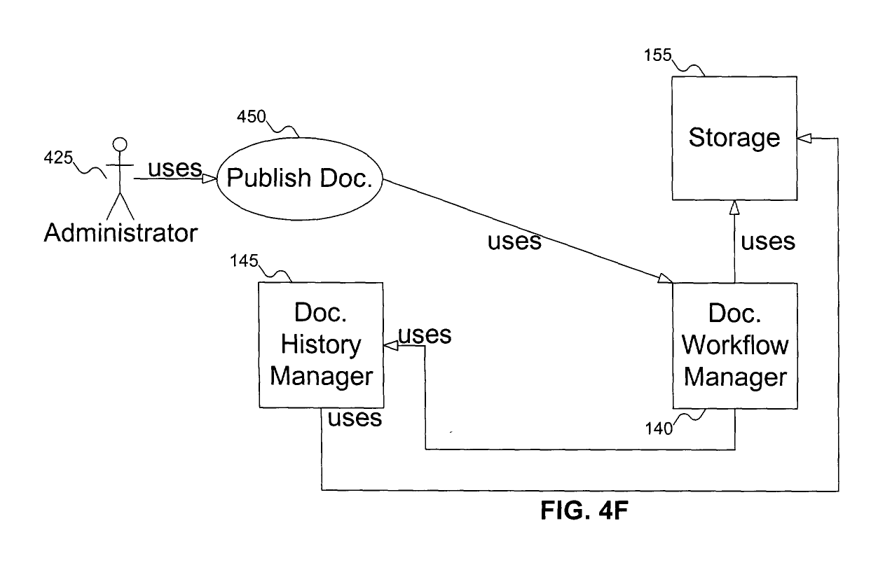

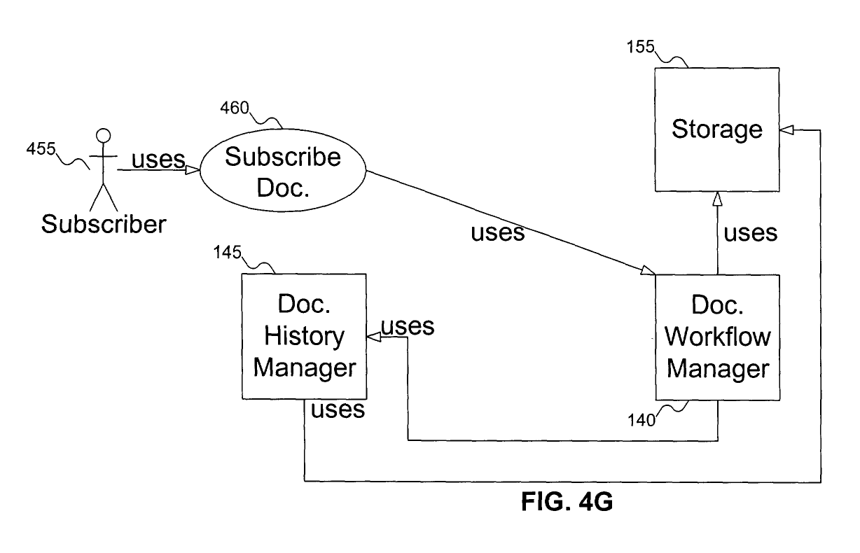

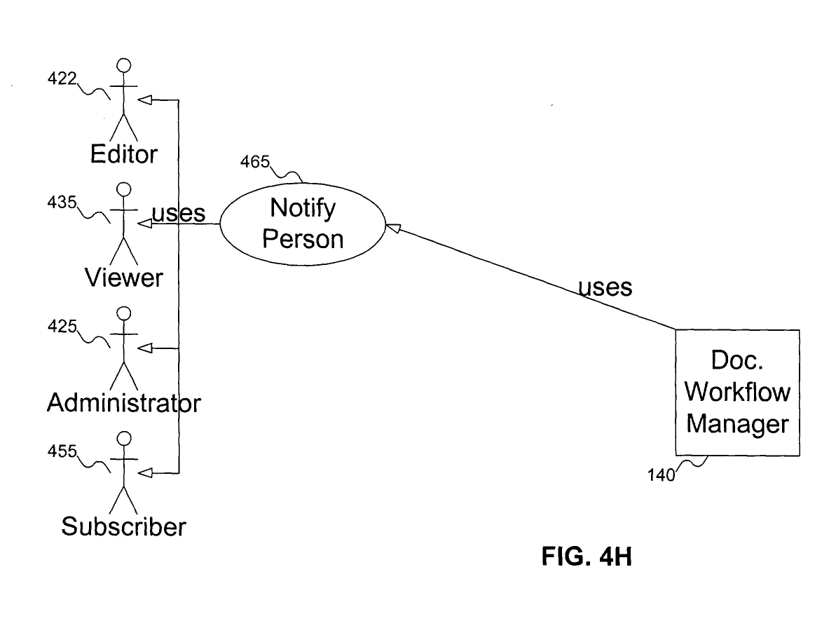

FIGS. 4A-4H show use cases for manipulating documents and document types in the computer system of FIG. 1, according to an embodiment of the invention. In FIG. 4A, the process of creating a new document type is shown. Type author 405, a user empowered to define a new document type, uses document type manager 130 to define a new document type, which is preferably stored in storage 155. Included in the functionality of document type manager 130 is the ability to define new item types.

In FIG. 4B, the process for creating a document is shown. Documents can be created by author 415. Document content manager 150 uses document type manager 130 to determine the type of the new document. The document can be routed to others using document workflow manager 140. The act of creating the document, along with any other activities on the document, is logged in document history manager 145. The document itself is preferably stored in storage 155.

In FIG. 4C, the process for editing a document is shown. Documents can be edited by author 415, by editor 422, or by administrator 425. Using document content manager 150, the contents of the document can be retrieved from storage 155, edited, and returned to storage 155. The edited document can be routed using document workflow manager 140, and the activity logged in document history manager 145.

In FIG. 4D, the process for viewing a document is shown. Documents can be viewed by author 415, by editor 422, by viewer 435, or by administrator 425. Using document view manager 135, the contents of the document are retrieved from storage 155, formatted according to the selected view by document view manager 135, and presented to the appropriate person. The activity is logged in document history manager 145.

In FIG. 4E, the process for viewing a document history is shown. Viewer 435 uses document history manager 145 to access the history of the document. The history is retrieved from storage 155, and presented to the user.

In FIG. 4F, the process for publishing a document is shown. Until a document is published, the contents of the document are kept private (unless specifically opened up for general viewing). Administrator 425 uses document workflow manager 140 to publish the document, which changes its state to a published state. Once published, the document is not available for editing, unless administrator 425 changes the state of the document back to an unpublished state. This change of state is stored in storage 155, and logged in document history manager 145.

In FIG. 4G, the process for subscribing to a document is shown. Subscriber 455 notifies document workflow manager 140 of his interest in the document. Document workflow manager 140 stores the subscriber information in storage 155, and logs the activity in document history manager 145. Note that subscribing to a document is an event. In the preferred embodiment, the event consists of the trigger of any activity on the document, and the associated action being notifying the subscriber of the activity. But a person skilled in the art will recognize that the trigger and/or associated action can be customized by the subscriber.

In FIG. 4H, the process for notifying users of activity is shown. This use case depicts users receiving “unsolicited” information, as opposed to the user-initiated activities in the use cases depicted in FIGS. 4A-4G. When document workflow manager 140 detects activity on a document, document workflow manager 140 notifies the various users. These can include editor 422, viewer 435, administrator 425, and subscriber 455.

Although FIGS. 4A-4H show various users performing certain activities, a person skilled in the art will recognize that embodiments of the invention are not limited to only the depicted users. For example, an administrator typically has very high-level access to all activities in the system. Thus, administrator 425 can perform any of the processes shown in FIGS. 4A-4H: document and item type definition, document creation, document editing, document viewing, document history viewing, publication, and subscription. In addition, there can be other roles not shown above.

FIGS. 5-7 show a definition of item and document types using the document type manager of FIG. 1, according to an embodiment of the invention. Although FIG. 5 (and FIGS. 8 and 11) depicts the data structures as tables of data, in a preferred embodiment, the data are stored in an object-oriented format. The functionality achieved by the object-oriented design is similar to that of the tabular format shown in FIGS. 5, 8, and 11: it is just a different implementational model. A person skilled in the art will also recognize that the description of FIGS. 5, 8, and 11 below only discuss very briefly the arrangements of the data structures, and that much more data can be stored in the design.

In FIG. 5, document instance table 505 stores information about particular instances of documents. For example, entry 507 in document instance table 505 identifies a particular instance of a document. The document has a name (in FIG. 5, the name is stored as a hexadecimal number, but a person skilled in the art will recognize that names using recognizable words can be used). One pointer points to the document type, and other points identify the values of fields in the document instance.

In particular, document instance 1x0001 is an RFI document type, which is stored in document type table 510. Note that there is more than one document type defined in document type table 510, although FIG. 5 does not show any document instances of other document types. Each entry in document type table 510 points to the fields used in the document, which are stored in item type table 515. For example, both document types RFI and RFQ include author and date fields. Each item type in item type table 515 stores the syntax and the semantics associated with the item type. For example, item type date (entry 517) defines a date has having date syntax, and having semantics enforcing a particular format for dates (in FIG. 5, using the North American convention of month, day, and year). item type author (entry 518) defines an author as having general syntax, meaning that any combination of characters can be entered, and no semantic rules to enforce.

Note further that roles can be assigned to individual item types. These roles are the roles shown in FIGS. 4A-4H above. Each role identifies particular types of users who can enter data to the fields. For example, both the date and author fields (entries 517 and 518, respectively) are assigned to the author role. This means that the author of the document (the user who creates the document) is responsible for completing these fields. Note that there can be different roles assigned to different fields. For example, a reply field in the RFI document is not filled out by the document author, but rather by some reviewing party.

Returning now to document instance table 505, the reader will understand that the field pointers point to the contents of the various fields for each document. This information is stored in document content table 520. Thus, document content table 520 stores entry 522, which stores author information for document instance 0x0001, and entry 523, which stored the date that document instance 1x0001 was opened.

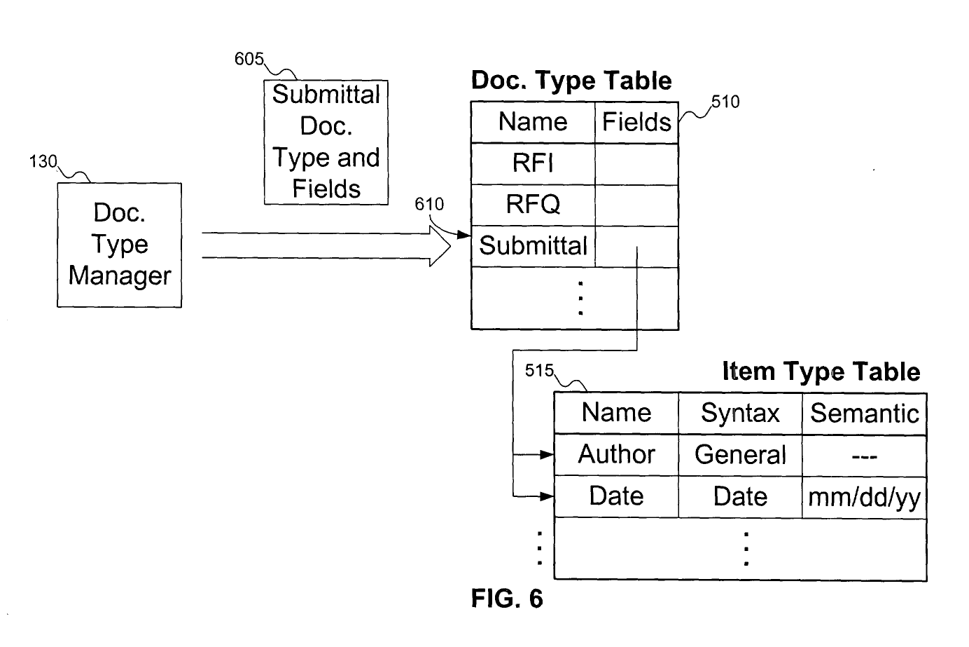

FIG. 6 shows the addition of a new document type to document type table 510. As the new document type is defined in document type manager 130, document type information 605 is stored in document type table 510, including references to the appropriate item types from item type table 515. For example, entry 610 reflects the new submittal document type.

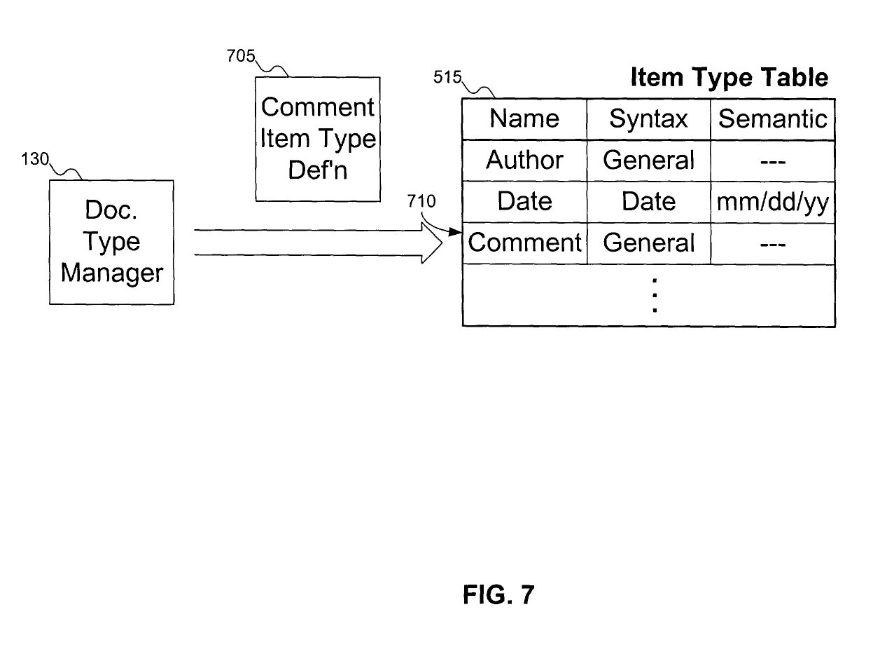

FIG. 7 shows the addition of a new item type to item type table 515. As the new item type is defined in document type manager 130, type information 705 is stored in item type table 515. For example, entry 710 reflects the new comment item type.

FIGS. 8-10 show a definition and use of a view for a document using the document view manager of FIG. 1, according to an embodiment of the invention. In FIG. 8, document type table 510 identifies the views, stored in document view table 805, that are associated with each document type. Document view table stores both pointers to the fields that are used in the view and the layout of the view. Note that, depending on the item types associated with a particular document type, it can happen that a single view definition can apply to more than one document type. For example, as shown in FIG. 8, the summary view (entry 810) is designed to present minimal information about a particular document, so that users can find the desired document quickly. Such a view, which uses only fields present in multiple document types, can be used as a view in multiple documents. As shown, both the RFI and RFQ document types use the summary view. In contrast, edit view (entry 815) is used only by the RFI document type.

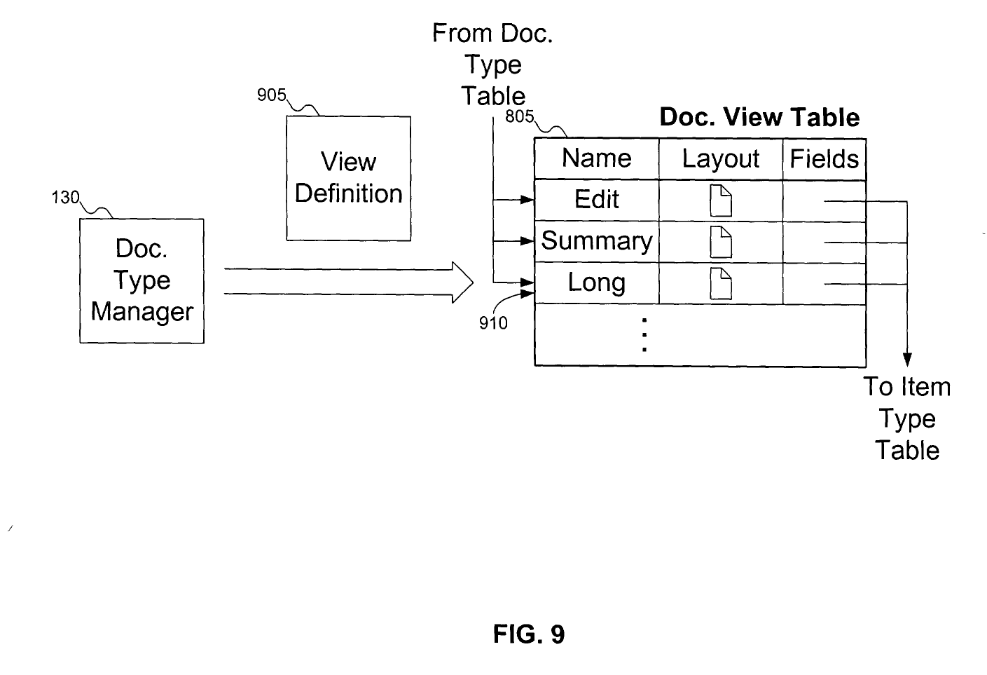

FIG. 9 shows a new view being added for a document type. As the new view is defined in document type manager 130, view definition 905 is added to document view table 805, storing the layout and fields of the new view. For example, entry 910 represents the new view for the document type.

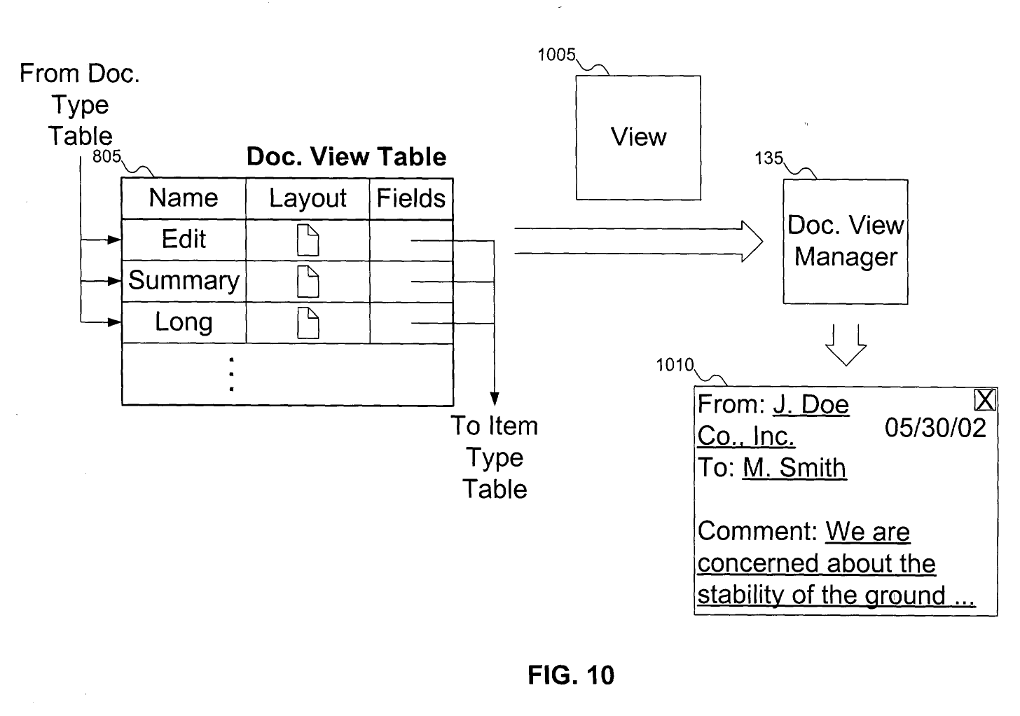

FIG. 10 shows the use of a view in presenting the document to a user. When a view is used to present a document to a user, document view manager 135 retrieves the view (view 1005) from document view table 805. Combined with the content of the document from document content table 520 (not shown in FIG. 10), the content can be presented to the user using the view. For example, presentation 1010 presents some document content using view 1005.

FIGS. 11-12 show a logging of activity and display of activity for a document using the document history manager of FIG. 1, according to an embodiment of the invention. In FIG. 11, document history manager 145 stores information about activities on the documents, such as M. Smith's editing of a document, in history table 1110. For example, entry 1115 reflects the activity by M. Smith on the document.

As discussed earlier, it is preferred that every action on a document be logged. This allows users who are authorized to view the document history. For example, in FIG. 12, document history manager 145 is shown retrieving information from history table 1110, so that the information can be presented to the user as presentation 1205. Note that, if authorized, the user can view the history of multiple documents at one time. Since document histories can be presented very briefly, many entries can be presented at a single time.

Although not reflected in FIG. 12, one capability of the system enables the user to select a particular history record, and learn more about that activity that generated that particular record. For example, the user could select record 1210, and learn more about the creation of the document by J. Doe.

FIG. 13 shows a workflow of a document using the document workflow manager of FIG. 1, according to an embodiment of the invention. As discussed earlier with reference to FIG. 4G, users can subscribe to documents. Subscribing is an example of an event, which is a trigger-associated action combination. Once the trigger occurs, the associated action is automatically performed. The most common type of event is a subscription, whereby the subscribing user wants to be notified (the associated action) when any activity occurs on the document (the trigger). But the trigger and associated action can respectively by any types of occurrences without limit. FIG. 13 shows an example of a different type of trigger event.

In FIG. 13, the subscribing user wants to be notified not when any activity occurs on the document, but rather when the document is published. Subscriber 455 gives information 1305, specifically including publish trigger 1307, to document workflow manager 140, which stores the event. Then, when administrator 425 publishes the document (trigger 1310), document workflow manager 140 sends notification 1315 to subscriber 455, notifying subscriber 425 of the publication of the document.

FIGS. 14A-14D show different workflows for a document using the document workflow manager of FIG. 1, according to an embodiment of the invention. In FIG. 14A, a broadcast routing is shown. When user 1405 has finished preparing document 1410, document workflow manager 140 routes document 1410 to users 1415. Document 1410 is routed to all users roughly simultaneously, so that each receives the same document at the roughly the same time.

FIG. 14B shows a different routing. In FIG. 14B, user 1405 has finished preparing document 1410. Document workflow manager 140 routes document 1410 to user 1420. User 1420 can then do whatever he desires with document 1410, including (perhaps) routing document 1410 to user 1425.

FIG. 14C shows a variation on the broadcast routing of FIG. 14A. In FIG. 14A, document 1410 is routed to users 1430 by document workflow manager 140. But then document workflow manager 140 blocks any further routing on the document until at least one of the users 1430 responds to the document routing. This is shown by stop block 1435. Once at least one of the users has responded, the document can be further routed, say to user 1440.

FIG. 14D shows a linear routing of document 1410. In FIG. 14D, document 1410 is to be routed to several people. But rather than routing document 1410 to all of the users at once, document 1410 is routed to one user at a time. Each can then review or otherwise process the document, before the document is routed to the next person in line. Thus, until user 1445 is finished processing document 1410, user 1450 cannot review the document, and until user 1450 is finished, user 1455 cannot review the document.

FIGS. 14A-14D are representative of the most common types of document routings. But a person skilled in the art will recognize that there are other types of routings, and that the routings of FIGS. 14A-14D can be combined to create new routing orders. Further, a person skilled in the art will recognize that the way in which a document is routed has nothing to do with what each user in the routing does with the document.

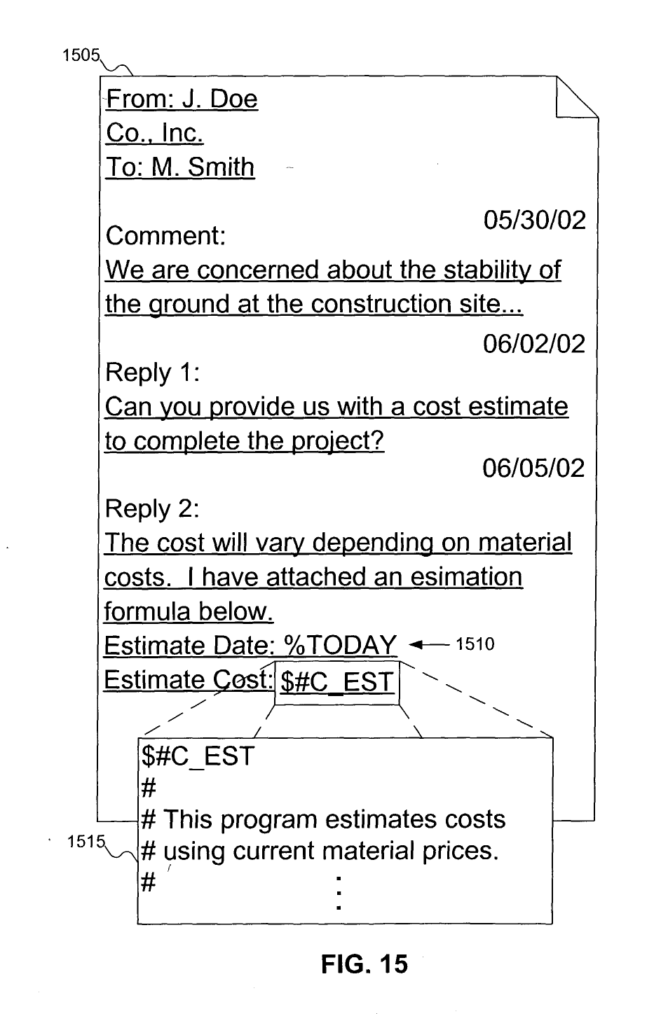

FIG. 15 shows a sample document with different value types as can be used in the computer system of FIG. 1, according to an embodiment of the invention. The reason document 1505 is presented is to explain the difference between different types of values that can be assigned to fields in documents. There are three types of values: assigned values, dynamic values, and programmatic values. Assigned values are values that are fixed for life: for example, a user's name, or a textual comment. Once entered, these values stay fixed (unless later edited).

Dynamic values are values that can change over time, but are not dependent on anything but time. For example, dynamic value 1510 is set to % TODAY, which is a variable storing the current date. Obviously, today's date will not change until tomorrow arrives, but once tomorrow arrives, the value will have changed.

Programmatic values are values that include pieces of code designed to solve some type of problem. For example, programmatic value 1515 includes a piece of code designed to estimate the cost of a construction project. Since the cost of the project depends on the current market prices for materials and labor, an assigned value is not a good estimate of the cost. By using the piece of code shown as programmatic value 1515, a better cost estimate can be made.

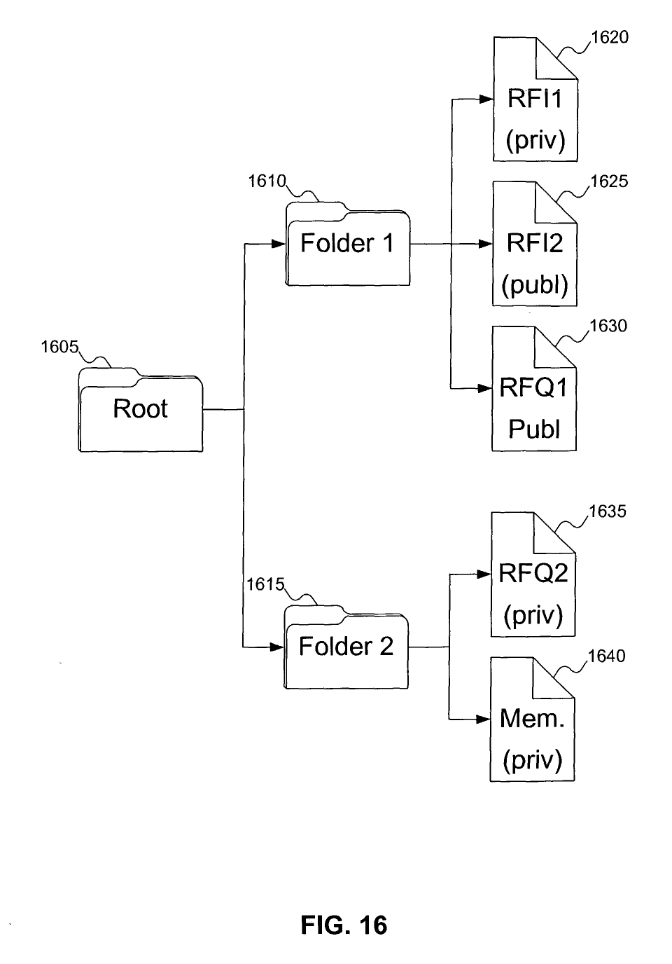

FIG. 16 shows a sample container structure for documents in the computer system of FIG. 1, according to an embodiment of the invention. Documents are represented to the user as stored in containers. Each container can contain multiple documents, and can nest other containers. By using a container structure, the user can be given access to many documents more simply: the user is just given access to the container. This avoids the need for each user to be specialized access to each document.

But limiting this access is the concept of publication. Documents can be private or public. Private documents can be viewed only by the users with specific permission to the documents: no-one else can view the documents, even if they have access to the container. To allow other users to view a private document, the document must be published. As discussed above with reference to FIG. 4F, once a document is published, its state is changed so that it cannot be edited further. Publishing also opens the document up for viewing by anyone with access to the container. In contrast, public documents are open to anyone with access to the container, even if the document is not yet published. Whether a document is public or private is tracked by the document workflow manager.

As an example, consider documents 1620, 1625, and 1630. Document 1620 is marked as private. As such, only users with specific permission to access document 1620 can view the document. Document 1625 is marked as public. Accordingly, anyone with access to containers 1605 or 1610 can view the document. Finally, document 1630 is published. This means that document 1630 is not envisioned as requiring further edit, and so its state is fixed. (Note that public documents can be published to prevent further editing, even though the function of opening of the document to the public is not needed.)

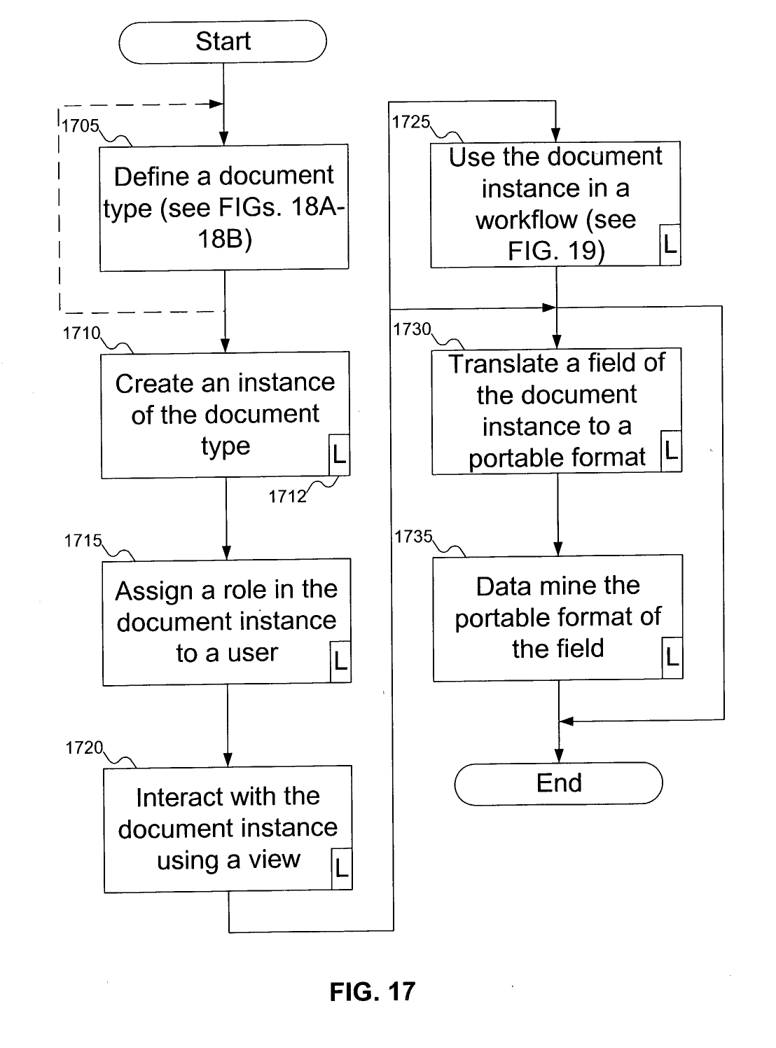

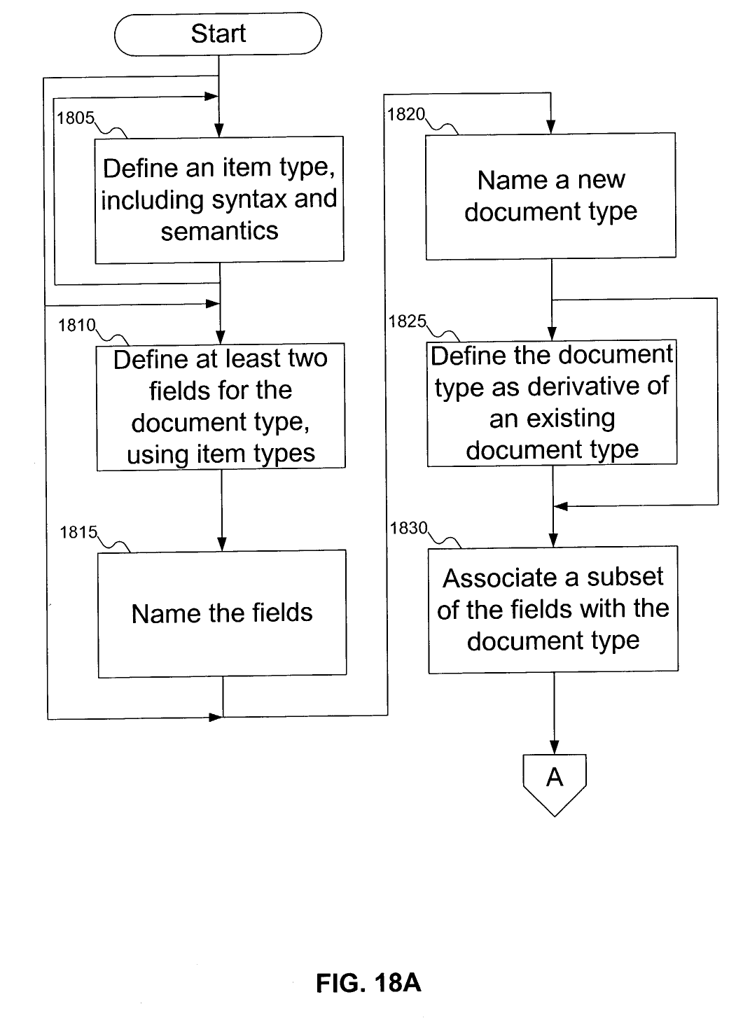

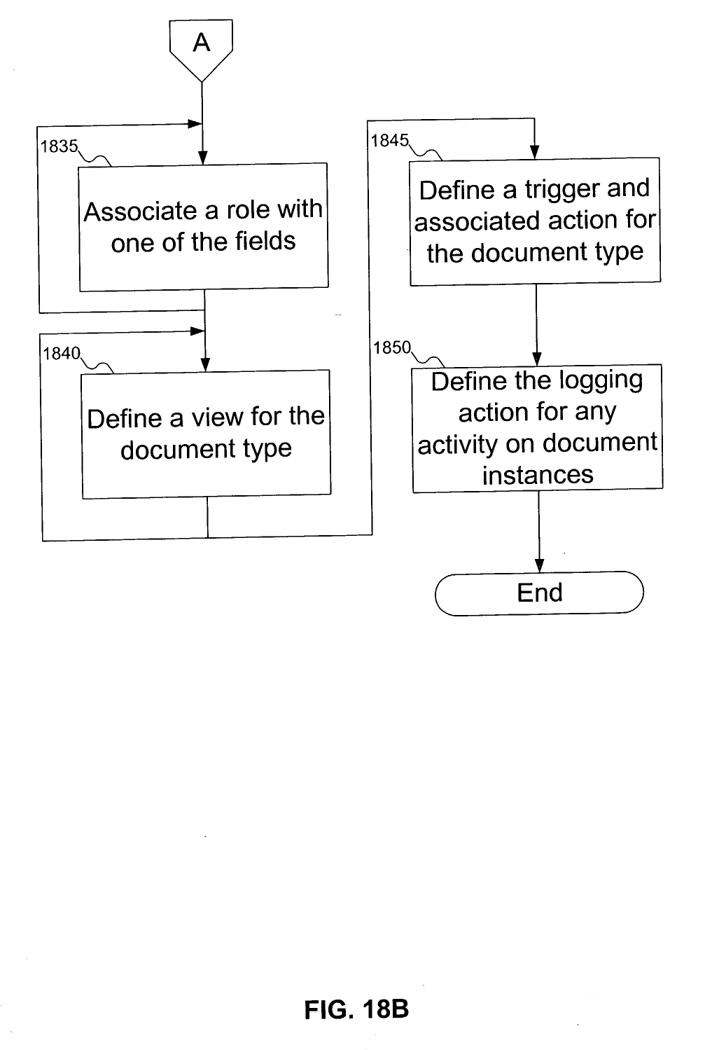

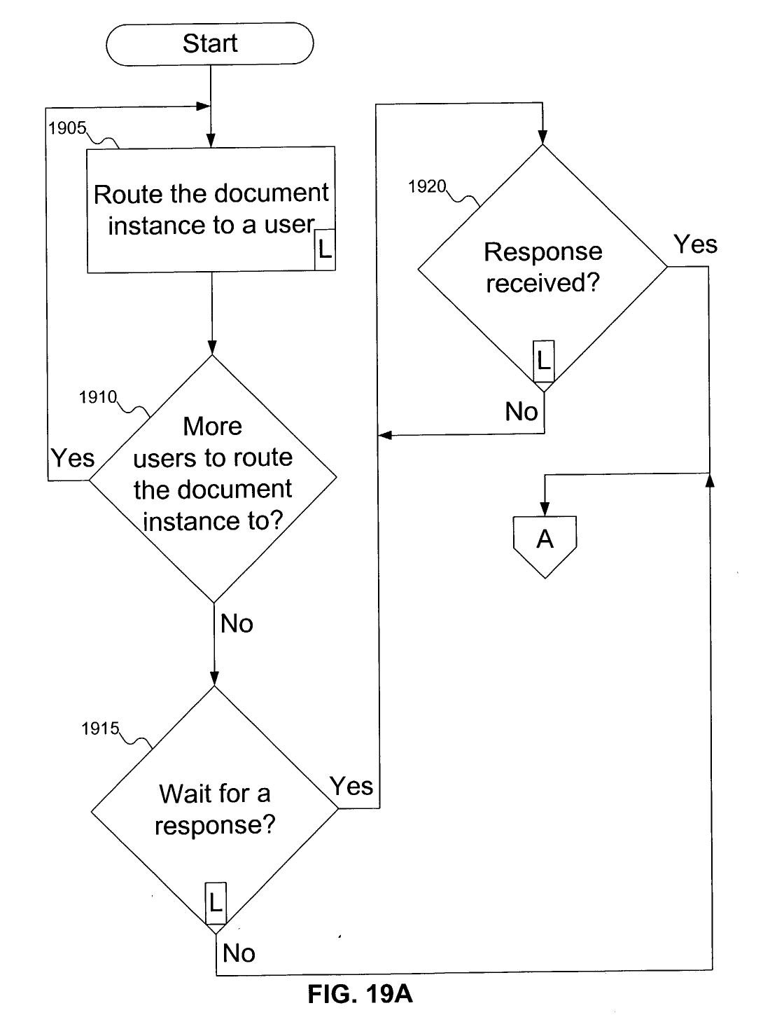

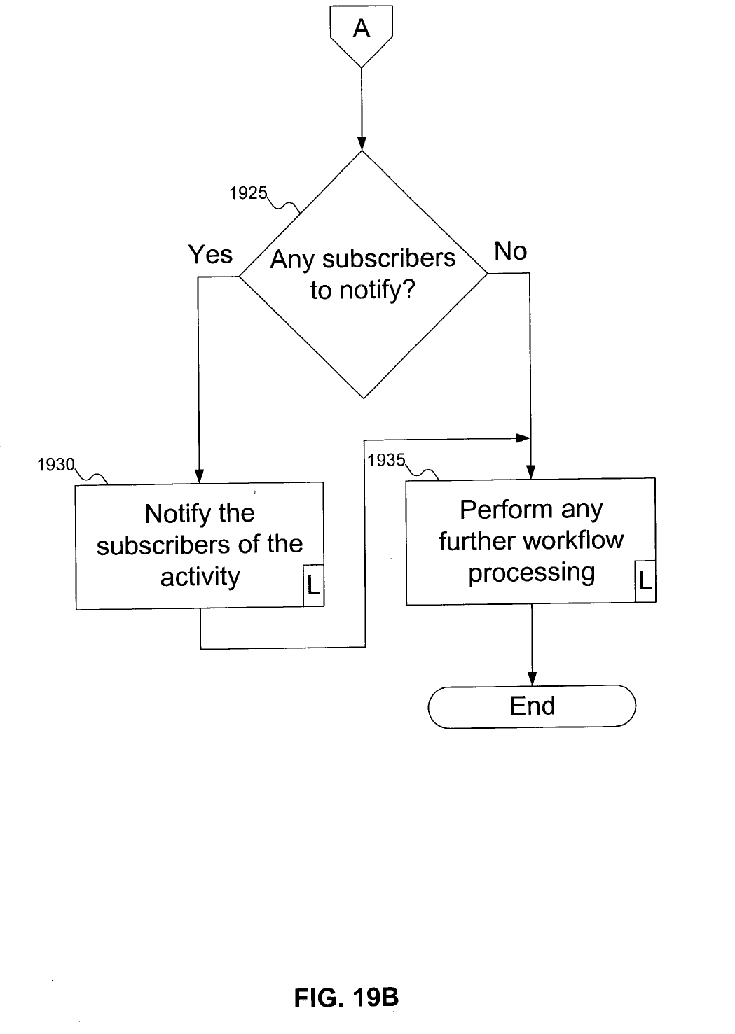

FIG. 17 shows a flowchart of the procedure for the lifecycle of a document in the computer system of FIG. 1, according to an embodiment of the invention. At step 1705, a document type is defined. Details of defining a document type are discussed further below with reference to FIGS. 18A-18B. As shown by the dashed line, the defining of a document type can be omitted, if the desired document types are already defined. At step 1710, a document instance of the document type is created. Note log symbol 1712: it indicates that a step in the flowchart is logged by the document history manager. Any other steps with the log symbol are also logged, and will not be explicitly mentioned in this discussion. At step 1715, a role in the document is assigned to a user. At step 1720, a user can interact with the document instance. As explained above, interacting can include creating the document, editing the document, viewing the document, and viewing the document history, among others. At step 1725, the document instance is used in a workflow. This use is explained further below with reference to FIGS. 19A-19B. As shown, the use of the document in the workflow, although useful, is not required. At step 1730, a field in the document can be translated to a portable format, such as the extensible Markup Language (XML), so that at step 1735, the portable format can be data-mined. As shown, steps 1730-1735 are optional, and can be omitted.

FIGS. 18A-18B show a flowchart of the procedure for defining a new document type in the computer system of FIG. 1, according to an embodiment of the invention. In FIG. 18A, at step 1805, an item type is defined, including syntax and semantics. At step 1810, at least two fields are defined for a document, using the defined item types. At step 1815, the fields are given names, which can differ from the names of the item types. At step 1820, a new document type is named. At step 1825, the document type can be defined as a derivative of an existing document type. A derived document type inherits the properties of the existing document type (such as fields, field item types, and layout, among others), and can be further embellished. At step 1830, a subset of the fields is associated with the document type.

At step 1835 (FIG. 18B), roles can be associated with the fields. At step 1840, a view can be defined for the document type. At step 1845, events (triggers and associated actions) can be defined for the document type. Finally, at step 1850, the document is given a specific event: the logging of any activities involving the document.

FIGS. 19A-19B show a flowchart of the procedure for managing a document workflow in the computer system of FIG. 1, according to an embodiment of the invention. In FIG. 19A, at step 1905, the document is routed to a user. At step 1910, the document workflow manager checks to see if there are any other users to whom the document should be routed. If there are, then at processing returns to step 1905 to route the document to other users. Assuming the document has been routed to all appropriate users, then at step 1915 the document workflow manager checks to see if the system should wait for a response from any of the users. If so, then at step 1920, the system waits for a response from any user to whom the document was routed.

At step 1925 (FIG. 19B), the system checks to see if any subscribers need to be notified. If so, then at step 1930, the subscribers are notified of the activity on the document. Finally, at step 1935, any further workflow processing is performed.

A person skilled in the art will recognize that an embodiment of the invention described above can be implemented using a computer. In that case, the method is embodied as instructions that comprise a program. The program may be stored on computer-readable media, such as floppy disks, optical discs (such as compact discs), or fixed disks (such as hard drives). The program can then be executed on a computer to implement the method. The program, or portions of its execution, can be distributed over multiple computers in a network.

Having illustrated and described the principles of the invention in a preferred embodiment thereof, it should be readily apparent to those skilled in the art that the invention can be modified in arrangement and detail without departing from such principles. All modifications coming within the spirit and scope of the accompanying claims are claimed.

1. An apparatus for working with extensible documents, comprising:
a computer including a storage, storing:
a document type manager, stored in the storage of the computer, operative to define a document type;
a document view manager, stored in the storage of the computer, operative to define a view for the document type; and
a document workflow manager, stored in the storage of the computer, operative to route a document instance of the document type to a user.

2. An apparatus according to claim 1, wherein the document type manager includes software operative to define an item type.

3. An apparatus according to claim 1, wherein the document type manager includes software operative to define a field using an item type.

4. An apparatus according to claim 3, wherein the document type manager further includes software operative to define a document type using the field.

5. An apparatus according to claim 3, wherein the document type manager further includes software operative to associate a role with the field.

7. An apparatus according to claim 1, wherein the document view manager further includes software operative to enable a user to interact with a document instance of the document type using the view.

9. An apparatus according to claim 1, wherein the document workflow manager includes:
software operative to route the document instance of the document type to at least two users; and
software operative to wait until at least one of the users responds to the document instance.

10. An apparatus according to claim 1, further comprising a document history manager, stored in the storage of the computer, operative to log an activity of the document instance of the document type.

12. An apparatus according to claim 1, further comprising a document content manager, operative to store a content of the document instance of the document type.

14. An apparatus for working with extensible documents, comprising:
a computer, including a storage, storing:
a document type;
a document instance of the document type;
a trigger for the document instance; and
an action associated with the trigger to perform when the trigger occurs.

15. An apparatus according to claim 14, wherein the associated action is a notification of a subscribed user.

16. A method for using extensible documents, comprising:
defining a document type, the document type including at least one role;
creating a document instance of the document type;
assigning the role to a user for the document instance;
interacting with a document instance of the document type; and
using the document instance in a workflow.

17. A method according to claim 16, wherein defining a document type includes:
defining at least one item type;
defining at least two fields using the item type; and
associating a subset of the fields with the document type.

18. A method according to claim 17, wherein defining at least two fields includes associating a role with at least one of the fields.

19. A method according to claim 17, wherein defining at least one item type includes defining a syntax and a semantic for the item type.

20. A method according to claim 17, wherein defining at least two fields includes assigning a name to each field.

21. A method according to claim 17, wherein defining at least one item type includes defining the item type as a derivative of a second item type.

22. A method according to claim 16, wherein defining a document type includes defining the document type as a derivative of a second document type.

43 is canceled.

44 is canceled.

45 is canceled.

46 is canceled.

27. A method according to claim 16, wherein interacting with a document instance includes creating the document instance.

48 is canceled.

49 is canceled.

30. A method according to claim 28, wherein assigning a value includes assigning a programmatic value to the field in the document instance.

31. A method according to claim 16, wherein interacting with a document instance includes viewing the document instance.

32. A method according to claim 16, wherein interacting with a document instance includes viewing the document instance using a view defined for the document type.

33. A method according to claim 16, wherein interacting with a document instance includes publishing the document instance.

34. A method according to claim 16, wherein interacting with a document instance includes subscribing to the document instance by a subscribed user.

35. A method according to claim 34, further comprising defining notifying a subscribed user as an action associated with a trigger for the document instance.

36. A method according to claim 16, wherein using the document instance in a workflow includes delivering the document instance to a second user.

37. A method according to claim 16, wherein using the document instance in a workflow includes:
routing the document instance to at least two users; and
waiting until at least one of the users responds.

38. A method according to claim 16, further comprising data mining the document instance.

39. A method according to claim 38, wherein data mining the document instance includes:
translating a field in the document instance into a portable format; and
processing the portable format of the field with a data mining utility.

40. Computer-readable media containing a program to use extensible documents, the program comprising:
software to define a document type, the document type including at least one role;
software to create a document instance of the document type;
software to assign the role to a user for the document instance;
software to interact with a document instance of the document type; and
software to use the document instance in a workflow.

41. Computer-readable media containing a program according to claim 40, wherein the software to define a document type includes:
software to define at least one item type;
software to define at least two fields using the item type; and
software to associate a subset of the fields with the document type.

42. Computer-readable media containing a program according to claim 40, wherein the software to define a document type includes software to define a view for the document type.

43 is canceled.

44 is canceled.

45 is canceled.

46 is canceled.

47. Computer-readable media containing a program according to claim 67, wherein the software to assign a value includes software to assign a dynamic value to the field in the document instance.

48 is canceled.

49 is canceled.

50. Computer-readable media containing a program according to claim 44, wherein the software to interact with a document instance includes software to subscribe to the document instance by a subscribed user.

51. Computer-readable media containing a program according to claim 40, wherein the software to use the document instance in a workflow includes software to deliver the document instance to a second user.

52. Computer-readable media containing a program according to claim 40, wherein the software to use the document instance in a workflow includes:
software to route the document instance to at least two users; and
software to wait until at least one of the users responds.

53. Computer-readable media containing a program according to claim 40, the program further comprising software to data mine the document instance.

54. Computer-readable media containing a program according to claim 53, wherein the software to data mine the document instance includes:
software to translate a field in the document instance into a portable format; and
software to process the portable format of the field with a data mining utility.

55. An apparatus according to claim 1, wherein the document workflow manager includes software operative to route a document instance of a document type to a user.

56. An apparatus according to claim 10, wherein the document history manager includes software operative to log an activity on a document instance of a document type.

57. An apparatus according to claim 12, wherein the document content manager includes software operative to store a content of a document instance of a document type.

58. A method according to claim 16, wherein defining a document type includes defining a view for the document type.

59. A method according to claim 16, wherein defining a document type includes defining an event for the document type.

60. A method according to claim 59, wherein defining an event includes defining a trigger and an action associated with the trigger.

61. A method according to claim 60, wherein defining a trigger includes:
defining as the trigger an activity on the document instance; and
defining as the action a logging of the activity in a history log.

62. A method according to claim 16, wherein interacting with a document instance includes assigning a value to a field in the document instance.

63. A method according to claim 62, wherein assigning a value includes assigning a dynamic value to the field in the document instance.

64. Computer-readable media containing a program according to claim 40, wherein the software to define a document type includes software to define an event for the document type.

65. Computer-readable media containing a program according to claim 64, wherein the software to define an event includes software to define a trigger and an action associated with the trigger.

66. Computer-readable media containing a program according to claim 65, wherein the software to define a trigger includes:
software to define as the trigger an activity on the document instance; and
software to define as the action a logging of the activity in a history log.

67. Computer-readable media containing a program according to claim 40, wherein the software to interact with a document instance includes software to assign a value to a field in the document instance.

68. Computer-readable media containing a program according to claim 67, wherein the software to assign a value includes software to assign a programmatic value to the field in the document instance.

69. Computer-readable media containing a program according to claim 40, wherein the software to interact with a document instance includes software to view the document instance using a view defined for the document type.

70. An apparatus according to claim 1, wherein the document view manager include software operative to define a view for a document type.
